(19) United States
(12) Patent Application Publication
(10) Pub. No.: US 2025/0246923 A1
(43) Pub. Date: Jul. 31, 2025

(54) ELECTRONIC DEVICE AND ELECTRONIC SYSTEM INCLUDING THE SAME

(71) Applicant: Samsung Display Co., LTD., Yongin-si (KR)

(72) Inventors: Jong Jae LEE, Yongin-si (KR); Tae Gon IM, Yongin-si (KR)

(21) Appl. No.: 18/908,646

(22) Filed: Oct. 7, 2024

(30) Foreign Application Priority Data
Jan. 29, 2024 (KR) 10-2024-0013474

(51) Int. Cl. H02J 7/00; G09G 3/20

(52) U.S. Cl. CPC H02J 7/0063; G09G 3/2092; H02J 7/00714; G09G 2310/0289; G09G 2330/028

(57) ABSTRACT

An electronic device includes a constant voltage supply unit which receives a first voltage from an external power supply device and generates a second voltage based on the first voltage, a driving circuit which receives the second voltage from the constant voltage supply unit and operates based on the second voltage, and a voltage adjusting unit which generates a control signal to change the first voltage based on the second voltage and a power source current corresponding to the second voltage.

The application claims priority to Korean Patent Application No. 10-2024-0013474, filed on Jan. 29, 2024, and all the benefits accruing therefrom under 35 U.S.C. § 119, the content of which in its entirety is herein incorporated by reference.

### BACKGROUND

### (1) Field

Embodiments of the invention relate to an electronic device and an electronic system including the electronic device.

### (2) Description of the Related Art

As information technology develops, the importance of a display device as a connection medium between a user and information is being emphasized. Accordingly, the use of display devices such as a liquid crystal display device and an organic light emitting display device is increasing in various fields.

A mobile electronic system, such as a smartphone and a tablet, may include a display device and various other electronic devices. The mobile electronic system may include a battery-based power supply device to supply a power source voltage to at least one electronic device therein.

### SUMMARY

In an electronic system, it may be desired to reduce power consumed in each electronic device to reduce power consumption of the electronic system.

Embodiments of the invention provide an electronic device that can be stably driven while reducing power consumption, and an electronic system including the electronic device.

An electronic device according to an embodiment of the invention includes a constant voltage supply unit which receives a first voltage from a power supply device and generates a second voltage based on the first voltage; a driving circuit which receives the second voltage from the constant voltage supply unit and operates based on the second voltage; and a voltage adjusting unit which generates a control signal to change the first voltage based on the second voltage and a power source current corresponding to the second voltage.

In an embodiment, the constant voltage supply unit may include a low drop-out (LDO) circuit. In such an embodiment, the voltage adjusting unit may sense the power source current flowing through the LDO circuit.

In an embodiment, the voltage adjusting unit may sense the second voltage and generate the control signal based on the power source current and the second voltage.

In an embodiment, when the second voltage is greater than a predetermined reference voltage value and the power source current is less than or equal to a predetermined reference current value, the voltage adjusting unit may generate the control signal to control the power supply device in a way such that the first voltage is lowered.

In an embodiment, when the second voltage is less than or equal to a predetermined reference voltage value and the power source current is less than or equal to a predetermined reference current value, the voltage adjusting unit may generate the control signal to control the power supply device in a way such that the first voltage is maintained.

In an embodiment, when the second voltage is less than or equal to a predetermined reference voltage value and the power source current is greater than a predetermined reference current value, the voltage adjusting unit may generate the control signal to control the power supply device in a way such that the first voltage is raised.

In an embodiment, the constant voltage supply unit may include a first LDO circuit which receives the first voltage; and a second LDO circuit which receives a third voltage. In such an embodiment, the voltage adjusting unit may sense the power source current flowing through the second LDO circuit.

In an embodiment, the LDO circuit may receives a third voltage.

In an embodiment, the driving circuit may receive data. In addition, the voltage adjusting unit may calculate the power source current based on the data.

In an embodiment, the driving circuit may perform an operation of displaying an image, and the data may be image data.

In an embodiment, the voltage adjusting unit may sense the second voltage and generate the control signal based on the power source current and the second voltage.

In an embodiment, the driving circuit may perform an operation of displaying an image. In such an embodiment, the voltage adjusting unit may generate the control signal every frame cycle of the driving circuit.

An electronic system according to another embodiment of the invention includes a power supply device which generates a first voltage based on a control signal; a constant voltage supply unit which generates a second voltage based on the first voltage; a driving circuit which operates based on the second voltage generated by the constant voltage supply unit; and a processor which generates the control signal based on the second voltage and a power source current corresponding to the second voltage.

In an embodiment, the constant voltage supply unit may include an LDO circuit. In such an embodiment, the processor may sense the power source current flowing through the at least one LDO circuit and the second voltage, and generate the control signal based on the power source current and the second voltage.

In an embodiment, when the second voltage is greater than a predetermined reference voltage value and the power source current is less than or equal to a predetermined reference current value, the processor may generate the control signal to control the power supply device in a way such that the first voltage is lowered.

In an embodiment, when the second voltage is less than or equal to a predetermined reference voltage value and the power source current is less than or equal to a predetermined reference current value, the processor may generate the control signal to control the power supply device in a way such that the first voltage is maintained.

In an embodiment, when the second voltage is less than or equal to a predetermined reference voltage value and the power source current is greater than a predetermined reference current value, the processor may generate the control signal to control the power supply device in a way such that the first voltage is raised.

In an embodiment, the constant voltage supply unit may include a first LDO circuit which receives the first voltage; and a second LDO circuit which receives a third voltage. In such an embodiment, the processor may sense the power source current flowing through the second LDO circuit.

In an embodiment, the LDO circuit may receives a third voltage.

In an embodiment, the electronic device may be a display device, and the processor may calculate the power source current based on image data transmitted to the display device.

### BRIEF DESCRIPTION OF THE DRAWINGS

The above and other features of this disclosure will become more apparent by describing in further detail embodiments thereof with reference to the accompanying drawings, in which:

FIG. 1 is a block diagram illustrating an electronic system according to an embodiment of the invention;

FIG. 2 is a block diagram illustrating an embodiment of an electronic device of FIG. 1;

FIG. 3 is a circuit diagram illustrating an embodiment of the electronic device of FIG. 1;

FIG. 4 is a circuit diagram illustrating another embodiment of the electronic device of FIG. 1;

FIG. 5 is a graph illustrating a power saving rate of the electronic device of FIG. 4.

FIG. 6 is a block diagram illustrating an electronic system according to another embodiment of the invention;

FIG. 7 is a block diagram illustrating an embodiment of the electronic system of FIG. 6;

FIG. 8 is a circuit diagram illustrating an embodiment of the electronic system of FIG. 6;

FIG. 9 is a graph for explaining an example of power source voltage control of an electronic device of FIG. 8;

FIG. 10 is a graph for explaining another example of power source voltage control of the electronic device of FIG. 8;

FIG. 11 is a graph for explaining another example of power source voltage control of the electronic device of FIG. 8;

FIG. 12 is a graph for explaining another example of power source voltage control of the electronic device of FIG. 8;

FIG. 13 is a graph for explaining another example of power source voltage control of the electronic device of FIG. 8;

FIG. 14 is a graph illustrating a power saving rate of an electronic device of FIG. 8;

FIG. 15 is a circuit diagram illustrating another embodiment of the electronic system of FIG. 6;

FIG. 16 is a block diagram illustrating an electronic system according to still another embodiment of the invention;

FIG. 17 is a block diagram illustrating an embodiment of the electronic system of FIG. 16;

FIG. 18 is a circuit diagram illustrating an embodiment of the electronic system of FIG. 16; and

FIG. 19 is a circuit diagram illustrating another embodiment of the electronic system of FIG. 16.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In order to clearly describe the invention, parts that are not related to the description are omitted, and the same or similar components are denoted by the same reference numerals throughout the specification. Therefore, the reference numerals described above may also be used in other drawings.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

In addition, the size and thickness of each component shown in the drawings are arbitrarily shown for convenience of description, and thus the invention is not necessarily limited to those shown in the drawings. In the drawings, thicknesses may be exaggerated to clearly express the layers and regions.

In addition, in the description, the expression “is the same” may mean “substantially the same”. That is, it may be the same enough to convince those of ordinary skill in the art to be the same. In other expressions, “substantially” may be omitted.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

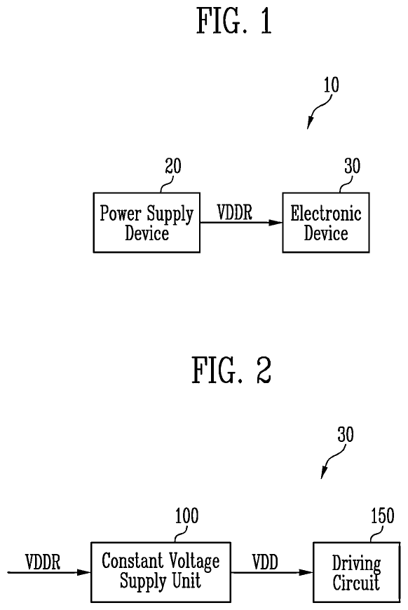

FIG. 1 is a block diagram illustrating an electronic system according to an embodiment of the invention.

Referring to FIG. 1, an electronic system 10 according to an embodiment of the invention may include a power supply device 20 and an electronic device 30. The power supply device 20 may supply a power source voltage VDDR to the electronic device 30. In an embodiment where the electronic system 10 is a mobile system, the power supply device 20 may include a battery. The power supply device 20 may include a power management integrated circuit (PMIC) that receives a main power source from a battery or an external power source and supplies the power source voltage VDDR to be used by the electronic device 30.

In an embodiment, as shown in FIG. 1, the electronic system 10 may include one electronic device 30, but this is only an example, and the electronic system 10 may include a plurality of electronic devices. The electronic device 30 may perform dependent functions of the electronic system 10. In an embodiment, for example, the electronic device 30 may be one of a display device, a storage device, a memory device, and a processing device. In an embodiment where the electronic system 10 includes a plurality of electronic devices, each of the electronic devices may receive the power source voltage from the power supply device 20. A voltage level of the power source voltage used by the plurality of electronic devices may be different from each other.

FIG. 2 is a block diagram illustrating an embodiment of an electronic device of FIG. 1.

Referring to FIG. 2, an embodiment of the electronic device 30 may include a constant voltage supply unit 100 and a driving circuit 150. The constant voltage supply unit 100 may receive the power source voltage VDDR from the power supply device 20 and supply an internal power source voltage VDD to the driving circuit 150. The driving circuit 150 may be a circuit that specifically performs operations of the electronic device 30, and may be operated by the internal power source voltage VDD. In FIG. 2, an embodiment where the constant voltage supply unit 100 transmits one internal power source voltage VDD to the driving circuit 150 is shown, but the invention is not limited thereto. In an embodiment where the driving circuit 150 uses the power source voltage having multiple voltage levels, the constant voltage supply unit 100 may generate a plurality of internal power source voltages and transmit the generated plurality of internal power source voltages to the driving circuit 150.

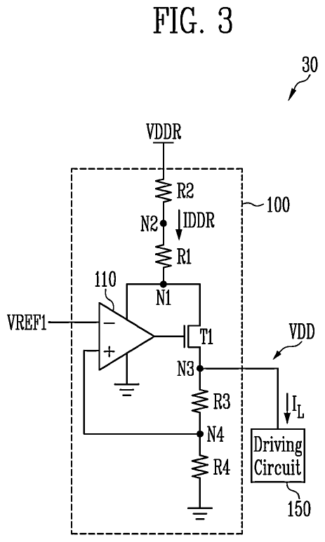

FIG. 3 is a circuit diagram illustrating an embodiment of the electronic device of FIG. 1.

Referring to FIG. 3, an embodiment of the electronic device 30 may include the constant voltage supply unit 100 and the driving circuit 150. In such an embodiment, resistors (resistance components) R1 and R2 may exist (or be defined) between the power source voltage VDDR and a node N1. The resistors R1 and R2 may be connected to a node N2. The resistors R1 and R2 may be line resistance components between the constant voltage supply unit 100 and the power supply device 20.

The constant voltage supply unit 100 may include a low drop-out (LDO) circuit. The LDO circuit may include an operational amplifier 110 that amplifies a difference in input voltages, a pass transistor T1, and feedback resistors R3 and R4. A comparison voltage VREF1 may be input to an inverting input terminal of the operational amplifier 110, and a voltage of a node N4 may be input to a non-inverting terminal of the operational amplifier 110. A first bias terminal of the operational amplifier 110 may be connected to the node N1, and a second bias terminal of the operational amplifier 110 may be connected to a ground. In such an embodiment, an output terminal of the operational amplifier 110 may be connected to a gate terminal of the pass transistor T1. The pass transistor T1 may be connected between the node N1 and the node N3, and the node N3 may be connected to the driving circuit 150. That is, the constant voltage supply unit 100 may output the internal power source voltage VDD through the node N3. Accordingly, a load current I_{L} may be transmitted from the node N3 to the driving circuit 150. In such an embodiment, the feedback resistor R3 may be connected between the node N3 and the node N4, and the feedback resistor R4 may be connected between the node N4 and the ground.

The driving circuit 150 may be configured or designed to operate with the power source voltage in a specific range. However, in an environment in which the driving circuit actually operates, there may be various variables, such as a voltage higher than the power source voltage set at the time of design being supplied or noise being introduced into the power source voltage due to external factors. That is, the power source voltage VDDR supplied from the power supply device 20 may change due to unexpected reasons. This may be a factor that interferes with the stable operation of the driving circuit 150.

Since the LDO circuit has high output voltage characteristics and noise rejection characteristics, it can be used in circuits that are sensitive to the power source voltage. In the LDO circuit, there may be a voltage difference between the node N1 and the node N3. Energy may be lost due to the voltage difference between the node N1 and the node N3. Therefore, the LDO circuit can be useful when a voltage difference between the power source voltage VDDR, which is an input voltage, and the internal power source voltage VDD, which is an output voltage, is not large.

The LDO circuit may detect an error between a voltage distributed by the feedback resistors R3 and R4 and a reference voltage VREF1, and control the pass transistor T1 to reduce the error between the two voltages according to a negative feedback structure.

For example, when the magnitude of the internal power source voltage VDD to be used by the driving circuit 150 is about 1.0 volt (V), and a voltage difference between the nodes N1 and N3 to drive the pass transistor T1 is at least about 0.3 V, the magnitude of the power source voltage VDDR may be determined depending on the magnitudes of the power source current IDDR and the resistors R1 and R2. The magnitude of the power source voltage VDDR may be determined by considering a margin of the power source current IDDR, a voltage drop margin of the pass transistor T1, and the internal power source voltage VDD. In an embodiment, for example, the magnitude of the power source voltage VDDR may be selected to be about 1.8V.

For stable operation of the driving circuit 150, it is desirable to select a large power source voltage VDDR. However, as the magnitude of the power source voltage VDDR increases, the power source current IDDR flowing through the resistors R1 and R2, which are line resistance components, also increases, thereby increasing power consumption. This may mean that in addition to the power consumed by the driving circuit 150, the power consumed by the LDO circuit also increases. Therefore, as the magnitude of the power source voltage VDDR increases, the power consumption of the electronic device 30 also undesirably increases.

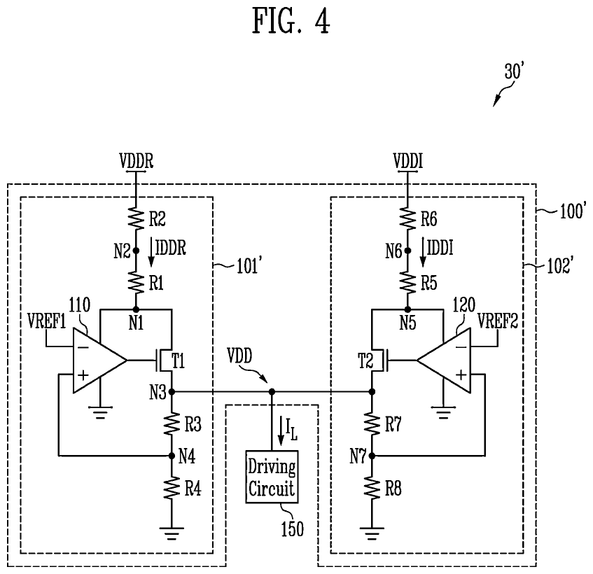

FIG. 4 is a circuit diagram illustrating another embodiment of the electronic device of FIG. 1.

Referring to FIG. 4, an embodiment of an electronic device 30′ may include a constant voltage supply unit 100′ and a driving circuit 150. Similar to the embodiment shown in FIG. 3, resistors (resistance components) R1 and R2 may exist between a power source voltage VDDR and a node N1. The resistors R1 and R2 may be connected to a node N2. The resistors R1 and R2 may be line resistance components between the node N1 and the power supply device 20.

The constant voltage supply unit 100′ may include a main LDO circuit 101′ and an auxiliary LDO circuit 102′. The main LDO circuit 101′ may include a LDO circuit as described above with reference to FIG. 3. The LDO circuit may include an operational amplifier 110 that amplifies a difference in input voltages, a pass transistor T1, and feedback resistors R3 and R4.

In such an embodiment, the auxiliary LDO circuit 102′ may receive a power source voltage VDDI. The power source voltage VDDI may be supplied from the power supply device 20 of FIG. 1.

The auxiliary LDO circuit 102′ may include an operational amplifier 120, a pass transistor T2, and feedback resistors R7 and R8. In such an embodiment, resistors (resistance components) R5 and R6 may exist between the power source voltage VDDI and a node N5. The resistors R5 and R6 may be connected to a node N6. The resistors R5 and R6 may be line resistance components between the node N5 and the power supply device 20.

In the auxiliary LDO circuit 102′, a comparison voltage VREF2 may be input to an inverting input terminal of the operational amplifier 120, and a voltage of a node N7 may be input to a non-inverting terminal of the operational amplifier 120. A first bias terminal of the operational amplifier 120 may be connected to the node N5, and a second bias terminal of the operational amplifier 120 may be connected to the ground. Meanwhile, an output terminal of the operational amplifier 120 may be connected to a gate terminal of the pass transistor T2. The pass transistor T2 may be connected between the node N5 and a node N3. In such an embodiment, the feedback resistor R7 may be connected between the node N3 and the node N7, and the feedback resistor R8 may be connected between the node N7 and a ground.

In an embodiment, a target output voltage of the auxiliary LDO circuit 102′ may be set to be slightly lower than a target output voltage of the conventional LDO circuit. In an embodiment, for example, when a reference voltage VREF1 is set so that the main LDO circuit 101′ outputs a voltage of about 1.0 V to the node N3, a reference voltage VREF2 may be set so that the auxiliary LDO circuit 102′ outputs a voltage of about 0.95 V to the node N3.

In an embodiment, as shown in FIG. 4, where the constant voltage supply unit 100′ further includes the auxiliary LDO circuit 102′, the power source voltage VDDR can be lowered. Since a load current I_{L} supplied to the driving circuit 150 is the sum of a current from the main LDO circuit 101′ and a current from the auxiliary LDO circuit 102′, a current flowing through the resistors R1 and R2, which are line resistance components of the main LDO circuit 101′, can be reduced. This may mean that the internal power source voltage VDD can be stably supplied even if the power source voltage VDDR is lowered. As a voltage level of the power source voltage VDDR is lowered, the power source current IDDR may decrease and the power source current IDDI of the auxiliary LDO circuit 102′ may increase.

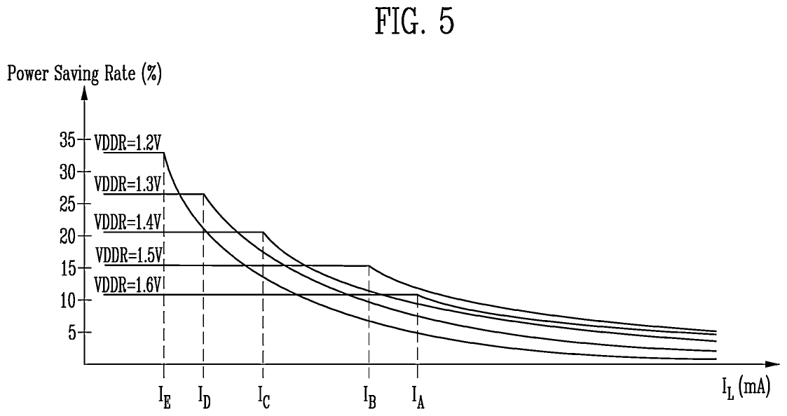

FIG. 5 is a graph illustrating a power saving rate of the electronic device of FIG. 4. Specifically, FIG. 5 is a graph showing power consumption saving rates when the magnitudes of power source voltages VDDR are 1.6 V, 1.5 V, 1.4 V, 1.3 V, and 1.2 V compared to the power consumption when the magnitude of the power source voltage VDDR is 1.8 V.

Referring to FIG. 5, when the magnitude of the power source voltage VDDR is set to 1.6 V, in a range where the magnitude of the load current I_{L} is less than or equal to a first threshold current value IA, power can be saved by about 10% compared to when the magnitude of the power source voltage VDDR is 1.8 V. However, in a range where the magnitude of the load current I_{L} exceeds the first threshold current value IA, the power saving rate may fall below 10%.

As shown in FIG. 5, when the magnitude of the power source voltage VDDR is set to 1.5 V, in a range where the magnitude of the load current I_{L} is less than or equal to a second threshold current value I_{B}, power can be saved by about 15% compared to when the magnitude of the power source voltage VDDR is 1.8 V. However, in a range where the magnitude of the load current I_{L} exceeds the second threshold current value I_{B}, the power saving rate may fall below 15%.

When the magnitude of the power source voltage VDDR is set to 1.4 V, in a range where the magnitude of the load current I_{L} is less than or equal to a third threshold current value I_{C}, power can be saved by about 20% compared to when the magnitude of the power source voltage VDDR is 1. 8V. However, in a range where the magnitude of the load current I_{L} exceeds the third threshold current value I_{C}, the power saving rate may fall below 20%.

When the magnitude of the power source voltage VDDR is set to 1.3 V, in a range where the magnitude of the load current I_{L} is less than or equal to a fourth threshold current value I_{D}, power can be saved by about 26% compared to when the magnitude of the power source voltage VDDR is 1.8 V. However, in a range where the magnitude of the load current I_{L} exceeds the fourth threshold current value I_{D}, the power saving rate may fall below 26%.

When the magnitude of the power source voltage VDDR is set to 1.2 V, in a range where the magnitude of the load current I_{L} is less than or equal to a fifth threshold current value I_{E}, power can be saved by about 33% compared to when the magnitude of the power source voltage VDDR is 1.8 V. However, in a range where the magnitude of the load current I_{L} exceeds the fifth threshold current value I_{E}, the power saving rate may fall below 33%.

Referring to FIG. 5, the lower the magnitude of the power source voltage VDDR is set, the higher the power saving rate can be achieved below the threshold current value. However, the lower the magnitude of the power source voltage VDDR is set, the greater the fall in power saving rate due to the increase in load current in a range exceeding the threshold current value.

When the electronic device 30′ operates, the driving circuit 150 may use only a small amount of current, but may use a large amount of current depending on conditions. That is, the driving circuit 150 may use a wide range of load current I_{L}. As described with reference to FIG. 5, when the power source voltage VDDR is lowered, it may be desired to reduce power consumption when the load current I_{L} supplied to the driving circuit 150 is below the threshold current value, but when the load current I_{L} increases, power consumption may actually increase further.

According to another embodiment of the invention, the power source voltage VDDR can be changed by sensing the internal power source voltage VDD supplied to the driving circuit of the electronic device and the power source current IDDI flowing through the auxiliary LDO circuit. That is, by supplying the power source voltage VDDR optimally selected based on the magnitude of the power source current IDDI flowing through the auxiliary LDO circuit to the electronic device 40, the power saving rate of the constant voltage supply unit can be maximized even if the load current I_{L} varies in a wide range.

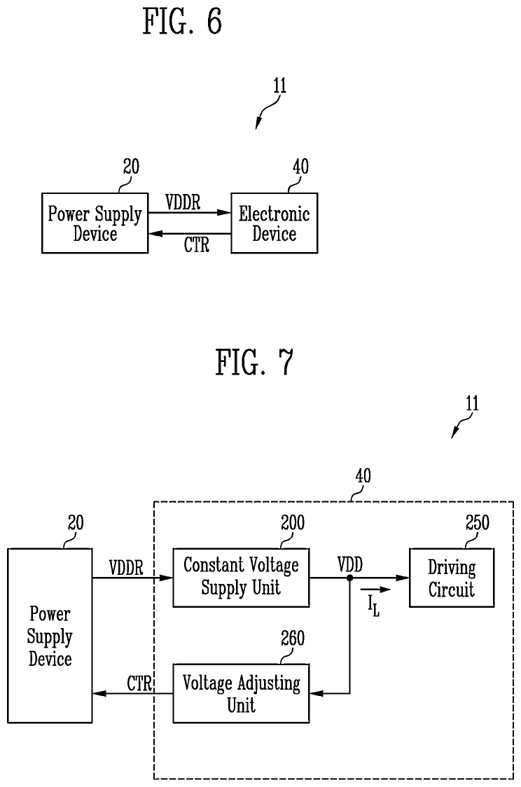

FIG. 6 is a block diagram illustrating an electronic system according to another embodiment of the invention.

Referring to FIG. 6, an electronic system 11 according to another embodiment of the invention may include a power supply device 20 and an electronic device 40. As described above with reference to FIG. 1, the power supply device 20 may supply a power source voltage VDDR to the electronic device 40. Hereinafter, any repetitive detailed descriptions of the same or like elements as those of the electronic system 10 of FIG. 1 will be omitted.

The power supply device 20 may supply the power source voltage VDDR to be used by the electronic device 40. In an embodiment, the electronic device 40 may generate a control signal CTR and transmit the control signal CTR to the power supply device 20. The power supply device 20 may adjust a voltage level of the power source voltage VDDR based on the control signal CTR. In such an embodiment, the electronic device 40 may generate the control signal CTR based on an internal power source voltage and a load current.

FIG. 7 is a block diagram illustrating an embodiment of the electronic system of FIG. 6.

In an embodiment, as described above with reference to FIG. 6, the electronic system 11 may include the power supply device 20 and the electronic device 40. In such an embodiment, as shown in FIG. 7, the electronic device 40 may include a constant voltage supply unit 200, a driving circuit 250, and a voltage adjusting unit 260. The constant voltage supply unit 200 may receive the power source voltage VDDR from the power supply device 20 and supply an internal power source voltage VDD to the driving circuit 250. The voltage adjusting unit 260 may sense the internal power source voltage VDD or a power source current IDDI and generate the control signal CTR. The control signal CTR generated by the voltage adjusting unit 260 may be transmitted to the power supply device 20. In an embodiment, the voltage adjusting unit 260 may be implemented as a processor.

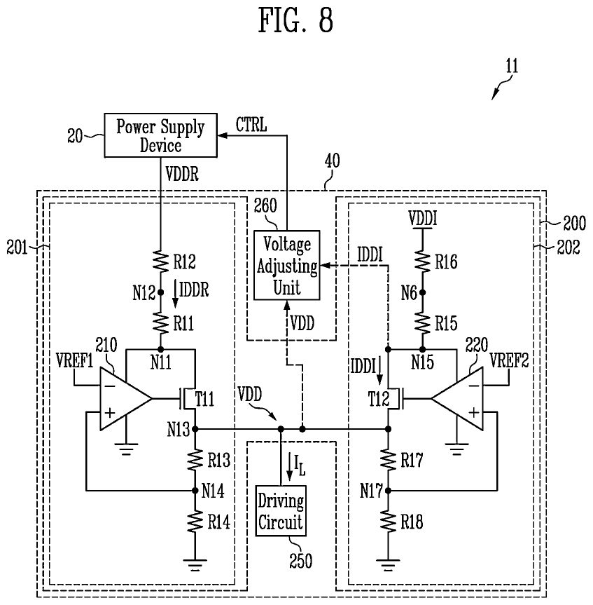

FIG. 8 is a circuit diagram illustrating an embodiment of the electronic system of FIG. 6.

In an embodiment, as described above with reference to FIG. 6, the electronic system 11 may include the power supply device 20 and the electronic device 40. In such an embodiment, as described above with reference to FIG. 7, the electronic device 40 may include the constant voltage supply unit 200, the driving circuit 250, and the voltage adjusting unit 260.

In such an embodiment, as shown in FIG. 8, the constant voltage supply unit 200 may include a main LDO circuit 201 and an auxiliary LDO circuit 202. The main LDO circuit 201 may be a main voltage supply unit of the constant voltage supply unit 200. The main LDO circuit 201 may include resistors R11 and R12, an operational amplifier 210, a pass transistor T11, and feedback resistors R13 and R14. The auxiliary LDO circuit 202 may be an auxiliary voltage supply unit of the constant voltage supply unit 200. The auxiliary LDO circuit 202 may include resistors R15 and R16, an operational amplifier 220, a pass transistor T12, and feedback resistors R17 and R18. The resistors R11 and R12 corresponding to line resistance components may exist between the power source voltage VDDR and a node N11, and the resistors R15 and R16 corresponding to line resistance components may exist between the power source voltage VDDI and a node N15.

The constant voltage supply unit 200 of FIG. 8 may be configured substantially the same as the constant voltage supply unit 100′ shown in FIG. 4. Therefore, any repetitive detailed description of the constant voltage supply unit 200 will be omitted.

The voltage adjusting unit 260 may generate the control signal CTR based on the internal power source voltage VDD output to a node N13 and the power source current IDDI flowing through the auxiliary LDO circuit 202. The node N13 may be an output node of the constant voltage supply unit 200. In addition, the node N13 may be a power supply node of the driving circuit 250.

The voltage adjusting unit 260 may include a voltage sensing unit that senses a voltage of the node N13. In an embodiment, the voltage adjusting unit 260 may include a current sensing unit that senses the power source current IDDI flowing through the auxiliary LDO circuit 202. The current sensing unit of the voltage adjusting unit 260 may be implemented in various ways. In an embodiment, for example, the current sensing unit of the voltage adjusting unit 260 may sense a voltage of the node N15 and determine a drain-source voltage of the pass transistor T12 from voltages of the nodes N15 and N13. The current sensing unit of the voltage adjusting unit 260 may determine the power source current IDDI, which is a current flowing through the pass transistor T12, based on the drain-source voltage of the pass transistor T12. However, this is only an example and the current sensing unit of the voltage adjusting unit 260 may sense a load current I_{L} in various other ways.

The voltage adjusting unit 260 may generate a control signal CTRL to adjust the power source voltage VDDR based on the sensed internal power source voltage VDD and power source current IDDI. In an embodiment, for example, the voltage adjusting unit 260 may generate the control signal CTRL to adjust the power source voltage VDDR in the manner shown in Table 1 below.

TABLE 1

| | IDDI ≤ I_{T} | IDDI > I_{T} |
|---|---|---|
| VDD > V_{T} | VDDR Lowering | — |
| VDD ≤ V_{T} | Maintain VDDR | VDDR Rises |

For example, the voltage adjusting unit 260 may store a lookup table corresponding to Table 1 above. The voltage adjusting unit 260 may refer to the lookup table and generate the control signal CTRL to adjust the power source voltage VDDR based on the internal power source voltage VDD and the load current I_{L}.

Referring to Table 1, in an embodiment, when the internal power source voltage VDD is greater than a predetermined reference voltage value V_{T} and the load current I_{L} is less than or equal to a predetermined reference current value IT, the voltage adjusting unit 260 may generate a signal to lower the power source voltage VDDR.

In such an embodiment, when the internal power source voltage VDD is less than or equal to the reference voltage value V_{T} and the power source current IDDI is less than or equal to the reference current value IT, the current power source voltage VDDR may be maintained. In this case, the voltage adjusting unit 260 may not separately generate a control signal or may generate the control signal CTR to maintain the power source voltage VDDR.

In such an embodiment, when the internal power source voltage VDD is less than or equal to the reference voltage value V_{T} and the power source current DDI is greater than the reference current value IT, the voltage adjusting unit 260 may generate a signal to raise the power source voltage VDDR.

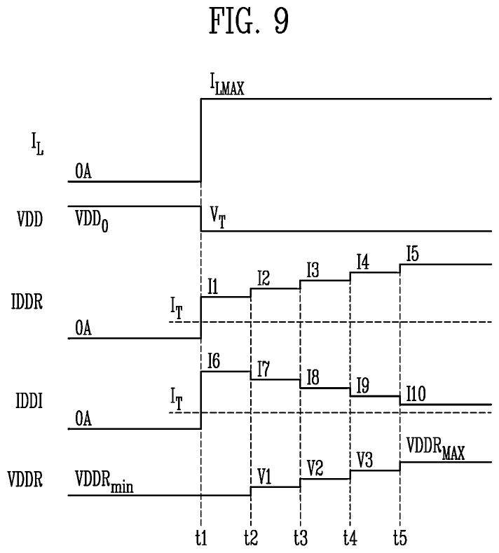

Hereinafter, a method for controlling the power source voltage VDDR of the electronic device 40 according to an embodiment of the invention will be described with reference to FIGS. 9 to 13. According to the method of controlling the power source voltage VDDR according to an embodiment of the invention, even if the power source voltage VDDR is lowered, the load current I_{L} having a desired level can be supplied through the supply of current from the power source voltage VDDI.

FIG. 9 is a graph for explaining an example of power source voltage control of an electronic device of FIG. 8. In an embodiment of the invention, the electronic device 40 may be a display device. In such an embodiment, the voltage adjusting unit 260 may sense the internal power source voltage VDD and the load current I_{L} every frame cycle and generate the control signal CTR based thereon. In FIG. 9, time points t2, t3, t4, and t5 may be time points when the voltage adjusting unit 260 senses the internal power source voltage VDD and the load current I_{L} and generates the control signal CTR.

Referring to FIG. 9, before a time point t1, the load current I_{L}, the power source current IDDR, and the power source current IDDI may have a current value of zero ampere 0 A, the internal power source voltage VDD may maintain a voltage value VDD₀, and the power source voltage VDDR may maintain a minimum voltage value VDDRmin.

At the time point t1, the load current I_{L} may increase rapidly and reach a maximum load current value I_{LMAX}. At the time point t1, as the load current I_{L} increases rapidly, the internal power source voltage VDD may fall to the reference voltage value V_{T}. As the load current I_{L} rapidly increases to the maximum load current value I_{LMAX}, it may be difficult to supply the rapidly increasing load current I_{L} only with the power source current IDDR output to the main LDO circuit. Therefore, it may be difficult to maintain the internal power source voltage VDD output to the node N13 only with the main LDO circuit. In this case, in response to the lowering internal power source voltage VDD, the auxiliary LDO circuit may increase the power source current IDDI to a current value 16. Accordingly, at the time point t1, the power source current IDDR may increase to a current value 11 and the power source current IDDI may increase to the current value 16. Here, the current values 11 and 16 may be greater than the reference current value IT.

In a section of the time point t1 to the time point t2, the voltage adjusting unit 260 may sense the internal power source voltage VDD and the power source current IDDI to determine whether to adjust the power source voltage VDDR. In the section t1 to t2, since a voltage level of the internal power source voltage VDD is equal to the reference voltage value V_{T} and a current level of the power source current IDDI is greater than the reference current value IT, the voltage adjusting unit 260 may determine to raise the power source voltage VDDR. The voltage adjusting unit 260 may generate the control signal CTRL to raise the power source voltage VDDR and transmit the control signal CTRL to the power supply device 20. Accordingly, at a time point t2, the power source voltage VDDR may rise to a voltage value V1. Accordingly, the power source current IDDR may increase to a current value 12. As the power source current IDDR increases, the power source current IDDI may decrease to a current value 17.

In sections of the time point t2 to the time point t3, the time point t3 to the time point t4, and the time point t4 to the time point t5, the voltage level of the internal power source voltage VDD may be equal to the reference voltage value V_{T} and the current level of the power source current IDDI may be greater than the reference current value IT. That is, in the sections of the time point t2 to the time point t3, the time point t3 to the time point t4, and the time point t4 to the time point t5, since the internal power source voltage VDD has a value equal to or lower than the reference voltage value V_{T}, and the power source current IDDI has a value greater than the reference current value IT, the main LDO circuit and the auxiliary LDO circuit may operate together to supply the load current I_{L}. In this case, if the power source current IDDI from the auxiliary LDO circuit is greater than the reference current value IT, the voltage adjusting unit 260 may generate the control signal to raise the power source voltage VDDR. Through such an operation, the voltage adjusting unit 260 may continuously increase the power source current IDDR of the main LDO circuit such that the power source current IDDI flowing from the auxiliary LDO circuit may be reduced.

Accordingly, as shown in FIG. 9, in the sections of the time point t2 to the time point t3, the time point t3 to the time point t4, and the time point t4 to the time point t5, since the power source current IDDI from the auxiliary LDO circuit is greater than the reference current value IT, the power source voltage VDDR may rise sequentially to voltage values V2 and V3 and a maximum voltage value VDDR_{MAX}. In such an embodiment, at time points t3, t4, and t5, the power source current IDDR from the main LDO circuit may increase sequentially to current values 13, 14, and 15. Accordingly, the power source current IDDI from the auxiliary LDO circuit may decrease sequentially to current values 18, 19, and 110.

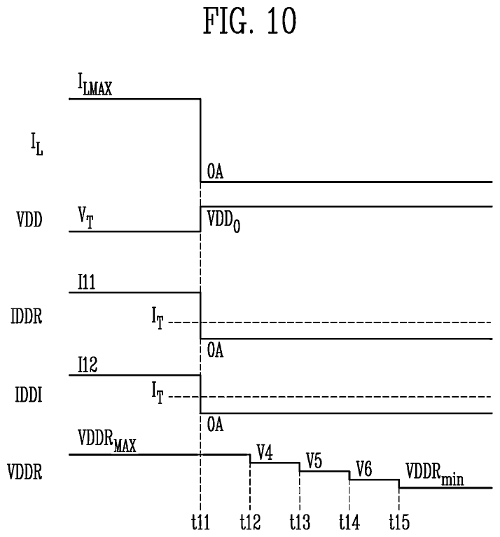

FIG. 10 is a graph for explaining another example of power source voltage control of the electronic device of FIG. 8.

Referring to FIG. 10, before a time point t11, the load current I_{L} may maintain the maximum load current value I_{LMAX}, the power source current IDDR and the power source current IDDI may be current values I11 and I12, respectively, the internal power source voltage VDD may maintain the reference voltage value V_{T}, and the power source voltage VDDR may maintain the maximum voltage value VDDR_{MAX}.

At the time point t11, the load current I_{L} may decrease rapidly and reach a current value of zero ampere 0 A. Accordingly, at the time point t11, the power source current IDDR and the power source current IDDI may also have a current value of zero ampere 0 A. In addition, at the time point t11, the internal power source voltage VDD may rise from the reference voltage value V_{T} to the voltage value VDD₀.

In a section of the time point t11 to the time point t12, the voltage adjusting unit 260 may sense the internal power source voltage VDD and power source current IDDI to determine whether to adjust the power source voltage VDDR. In the section of the time point t11 to the time point t12, since the voltage level of the internal power source voltage VDD is greater than the reference voltage value V_{T} and the current level of the power source current IDDI is less than the reference current value IT, the voltage adjusting unit 260 may determine to lower the power source voltage VDDR. That is, after the time point t11, since the load current I_{L} is reduced, the reduced load current I_{L} may be supplied only by the main LDO circuit. Accordingly, the power source current IDDI of the auxiliary LDO circuit and the power source current IDDR of the main LDO circuit may be reduced below the reference current value IT. Since the auxiliary LDO circuit may not operate, the voltage adjusting unit 260 may control the power supply device 20 so that the power source voltage VDDR is lowered. Accordingly, at time points t12, t13, t14, and t15, the power source voltage VDDR may sequentially fall to voltage values V4, V5, and V6 and the minimum voltage value VDDRₘᵢₙ.

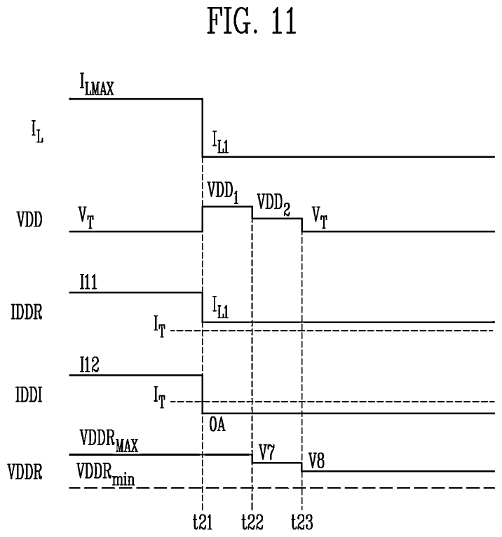

FIG. 11 is a graph for explaining another example of power source voltage control of the electronic device of FIG. 8.

Referring to FIG. 11, before a time point t21, the load current I_{L} may maintain the maximum load current value I_{LMAX}, the power source current IDDR and the power source current IDDI may be the current values I11 and I12, respectively, the internal power source voltage VDD may maintain the reference voltage value V_{T}, and the power source voltage VDDR may maintain the maximum voltage value VDDR_{MAX}.

At the time point t21, the load current I_{L} may decrease somewhat and reach a current value I_{L1}. As the load current I_{L} decreases, at the time point t21, the power source current IDDI may have a current value of zero ampere 0 A and the power source current IDDR may be the same current value I_{L} as the load current I_{L}. Before the time point t21, since the internal power source voltage VDD is equal to the reference voltage value V_{T} and the power source current IDDI is greater than the reference current value I_{T}, at the time point t21, the internal power source voltage VDD may rise slightly from the reference voltage value V_{T} to a voltage value VDD₁.

In a section of the time point t21 to the time point t22, the voltage adjusting unit 260 may sense the internal power source voltage VDD and the power source current IDDI to determine whether to adjust the power source voltage VDDR. In the section of the time point t21 to the time point t22, since the voltage level of the internal power source voltage VDD is greater than the reference voltage value V_{T} and the current level of the power source current IDDI is less than the reference current value I_{T}, the voltage adjusting unit 260 may determine to lower the power source voltage VDDR. Accordingly, at a time point t22, the power source voltage VDDR may fall to a voltage value V7. In addition, at the time point t22, the internal power source voltage VDD may fall to a voltage value VDD₂.

Likewise, in a section of the time point t22 to the time point t23, since the voltage level of the internal power source voltage VDD is greater than the reference voltage value V_{T} and the current level of the power source current IDDI is less than the reference current value I_{L}, the power source voltage VDDR may fall to a voltage value V8, and the internal power source voltage VDD may fall to the reference voltage value V_{T}.

In a section after a time point t23, the current level of the power source current IDDI is smaller than the reference current value I_{T}, but since the magnitude of the internal power source voltage VDD is the same as the reference voltage value V_{T}, the power source voltage VDDR may be maintained.

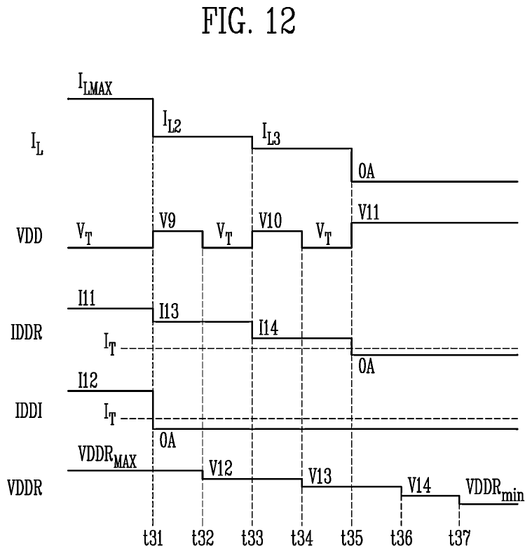

FIG. 12 is a graph for explaining another example of power source voltage control of the electronic device of FIG. 8.

Referring to FIG. 12, before a time point t31, the load current I_{L} may maintain the maximum load current value I_{LMAX}, the power source current IDDR and the power source current IDDI may be the current values I11 and I12, respectively, the internal power source voltage VDD may maintain the reference voltage value V_{T}, and the power source voltage VDDR may maintain the maximum voltage value VDDR_{MAX}.

At the time point t31, the load current I_{L} may decrease from the maximum load current value I_{LMAX} to the current value I_{L1}. Accordingly, at the time point t31, the internal power source voltage VDD may rise from the reference voltage value V_{T} to a voltage value V9. The load current I_{L} corresponding to the internal power source voltage VDD that rises at the time point t31 may be a current value I_{L2}. Accordingly, at the time point t31, the power source current IDDI may have a current value of zero ampere 0 A, and the power source current IDDR may be a current value 113. The current value 113 may be the same current value I_{L1} as the load current I_{L}. In addition, at the time point t31, the internal power source voltage VDD may rise slightly from the reference voltage value V_{T} to the voltage value V9.

In a section of the time point t31 to the time point t32, the voltage adjusting unit 260 may sense the internal power source voltage VDD and the power source current IDDI to determine whether to adjust the power source voltage VDDR. In the section of the time point t31 to the time point t32, since the voltage level of the internal power source voltage VDD is greater than the reference voltage value V_{T} and the current level of the power source current IDDI is less than the reference current value I_{T}, the voltage adjusting unit 260 may determine to lower the power source voltage VDDR. Accordingly, at a time point t32, the power source voltage VDDR may fall to a voltage value V12. In addition, at the time point t32, the internal power source voltage VDD may fall to the reference voltage value V_{T}.

In a section of the time point t32 to the time point t33, since the voltage level of the internal power source voltage VDD is equal to the reference voltage value V_{T} and the current level of the power source current IDDI is less than the reference current value I_{T}, the voltage adjusting unit 260 may determine to maintain the power source voltage VDDR. In addition, at a time point t33, the load current I_{L} may decrease somewhat and reach a current value I_{L3} that is lower than the reference current value I_{T}. Accordingly, at the time point t33, the power source current IDDR may decrease slightly to a current value 114. In addition, the power source voltage VDDR is somewhat lowered at the time point t32, but since the power source current IDDR maintains the current value 113, at the time point t33, the internal power source voltage VDD may rise again from the reference voltage value V_{T} to a voltage value V10.

In a section of the time point t33 to the time point t34, since the voltage level of the internal power source voltage VDD is greater than the reference voltage value V_{T} and the current level of the power source current IDDI is less than the reference current value I_{T}, the voltage adjusting unit 260 may determine to lower the power source voltage VDDR. Accordingly, at a time point t34, the power source voltage VDDR may fall to a voltage value V13. in addition, at the time point t33, since the power source current IDDR decreases to the current value 114, at a time point t34, the internal power source voltage VDD may fall to the reference voltage value V_{T} due to the power source current IDDR reduced during the section t33 to t34.

In a section of the time point t34 to the time point t35, since the voltage level of the internal power source voltage VDD is equal to the reference voltage value V_{T} and the current level of the power source current IDDI is less than the reference current value I_{T}, the voltage adjusting unit 260 may determine to maintain the power source voltage VDDR. in addition, at a time point t35, the load current I_{L} may decrease to a current value of zero ampere 0 A. Accordingly, at the time point t35, the power source current IDDR may decrease to a current value of zero ampere 0 A. In addition, the internal power source voltage VDD may rise from the reference voltage value V_{T} to a voltage value V11.

Thereafter, in a section of the time point t36 to the time point t37 and the subsequent section, since the voltage level of the internal power source voltage VDD is greater than the reference voltage value V_{T} and the current level of the power source current IDDI is less than the reference current value I_{T}, the voltage adjusting unit 260 may determine to lower the power source voltage VDDR. Accordingly, at time points t36 and t37, the power source voltage VDDR may sequentially fall to the voltage value V14 and the minimum voltage value VDDRₘᵢₙ.

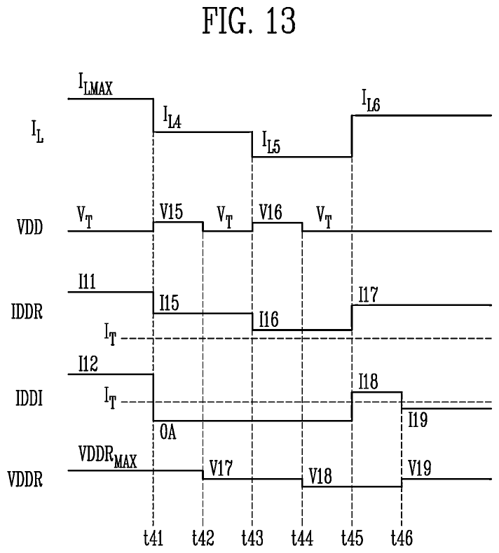

FIG. 13 is a graph for explaining another example of power source voltage control of the electronic device of FIG. 8.

Referring to FIG. 13, before a time point t41, the load current I_{L} may maintain the maximum load current value I_{LMAX}, the power source current IDDR and the power source current IDDI may be the current values I11 and I12, respectively, the internal power source voltage VDD may maintain the reference voltage value V_{T}, and the power source voltage VDDR may maintain the maximum voltage value VDDR_{MAX}.

At the time point t41, the load current I_{L} may decrease somewhat and reach a current value I_{L4} that is lower than the reference current value I_{T}. Accordingly, at the time point t41, the power source current IDDI may have a current value of zero ampere 0 A, and the power source current IDDR may be a current value 115. The current value 115 may be the same current value I_{L4} as the load current I_{L}. In addition, at the time point t41, the internal power source voltage VDD may rise slightly from the reference voltage value V_{T} to a voltage value V15.

In a section of the time point t41 to the time point t42, the voltage adjusting unit 260 may sense the internal power source voltage VDD and power source current IDDI to determine whether to adjust the power source voltage VDDR. In the section of the time point t41 to the time point t42, since the voltage level of the internal power source voltage VDD is greater than the reference voltage value V_{T} and the current level of the power source current IDDA is less than the reference current value I_{T}, the voltage adjusting unit 260 may determine to lower the power source voltage VDDR. Accordingly, at a time point t42, the power source voltage VDDR may fall to a voltage value V17. In addition, at the time point t42, the internal power source voltage VDD may fall to the reference voltage value V_{T}.

In a section of the time point t42 to the time point t43, since the voltage level of the internal power source voltage VDD is equal to the reference voltage value V_{T} and the current level of the power source current IDDI is less than the reference current value I_{T}, the voltage adjusting unit 260 may determine to maintain the power source voltage VDDR. In addition, at a time point t43, the load current I_{L} may decrease and reach a current value I_{L5} that is lower than the reference current value I_{T}. Accordingly, at the time point t43, the power source current IDDR may decrease to a current value 116. In addition, at the time point t43, the internal power source voltage VDD may rise slightly from the reference voltage value V_{T} to a voltage value V16.

In a section of the time point t43 to the time point t44, since the voltage level of the internal power source voltage VDD is greater than the reference voltage value V_{T} and the current level of the power source current IDDA is less than the reference current value I_{T}, the voltage adjusting unit 260 may determine to lower the power source voltage VDDR. Accordingly, at a time point t44, the power source voltage VDDR may fall to a voltage value V18. In addition, at the time point t44, the internal power source voltage VDD may fall to the reference voltage value V_{T}.

In a section of the time point t44 to the time point t45, since the voltage level of the internal power source voltage VDD is equal to the reference voltage value V_{T} and the current level of the power source current IDDA is less than the reference current value I_{T}, the voltage adjusting unit 260 may determine to maintain the power source voltage VDDR. In addition, at a time point t45, the load current I_{L} may increase to a relatively high current value I_{L6}. Accordingly, at the time point t45, the power source current IDDR may increase to a current value 117 and the power source current IDDI may increase to a current value 118.

Thereafter, in a section of the time point t45 to the time point t46, since the voltage level of the internal power source voltage VDD corresponds to the reference voltage value V_{T} and a current value 118 of the power source current IDDA is greater than the reference current value I_{T}, the voltage adjusting unit 260 may determine to raise the power source voltage VDDR. Accordingly, at a time point t46, the power source voltage VDDR may rise sequentially to a voltage value V19, and the power source current IDDI may decrease slightly to a current value 119. In a section after the time point t46, since the current level of the power source current IDDA is maintained lower than the reference current value I_{T} and the voltage level of the internal power source voltage VDD is maintained equal to the reference voltage value V_{T}, the power source voltage VDDR may be maintained.

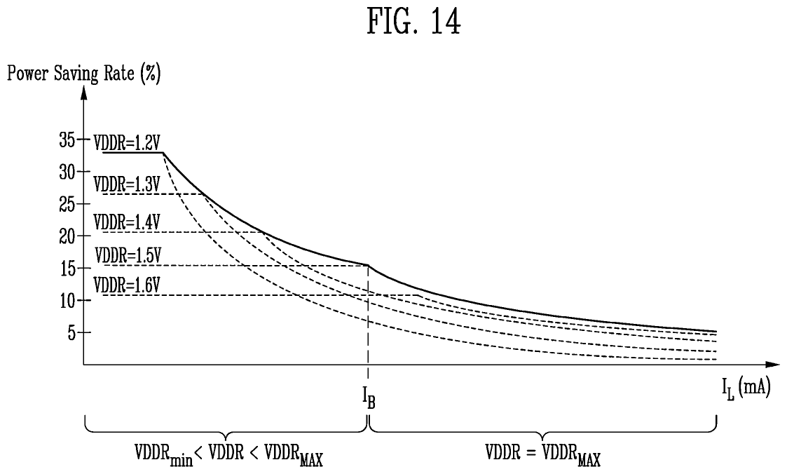

FIG. 14 is a graph illustrating a power saving rate of an electronic device of FIG. 8.

Referring to FIG. 14, a graph showing a power consumption saving rate when the power source voltage VDDR is controlled as described with reference to FIGS. 9 to 13 is shown compared to the power consumption when the magnitude of the power source voltage VDDR is fixed at 1.8 V.

In FIG. 14, power consumption saving rates when the magnitudes of power source voltages VDDR are 1.6 V, 1.5 V, 1.4 V, 1.3 V, and 1.2 V are shown as dotted lines, and the power consumption saving rate when the power source voltage VDDR is controlled as described with reference to FIGS. 9 to 13 is shown as a thick solid line.

When the load current I_{L} is less than the second threshold current value I_{B}, the power source voltage VDDR may be changed between the minimum voltage value VDDRₘᵢₙ and the maximum voltage value VDDR_{MAX} depending on the magnitude of the load current I_{L}. In FIG. 14, the minimum voltage value VDDRₘᵢₙ may be 1.2 V, and the maximum voltage value VDDR_{MAX} may be 1.5 V. In the graph of FIG. 14, when the power source voltage VDDR is 1.6 V, since there is no point in an entire section of the load current I_{L} that shows the highest power saving rate compared to other voltage values, 1.6 V is not used as the power source voltage VDDR.

When the load current I_{L} is greater than the second threshold current value I_{B}, the power source voltage VDDR may be fixed to the maximum voltage value VDDR_{MAX}.

As described above, the electronic device 40 according to an embodiment of the invention may control the magnitude of the power source voltage VDDR received from the power supply device 20 based on the power source load current IDDI and the internal power source voltage VDD. Accordingly, even if the load current I_{L} varies over a wide range, the constant voltage supply unit 200 of the electronic device 40 can always achieve a high or maximum power saving rate.

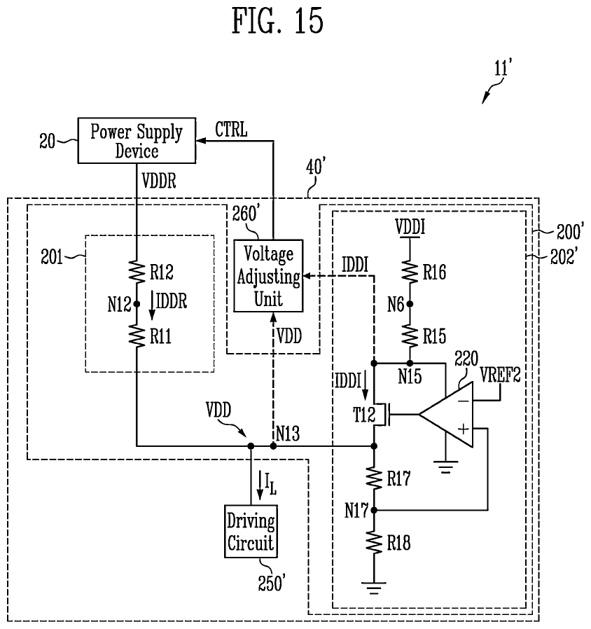

FIG. 15 is a circuit diagram illustrating another embodiment of the electronic system of FIG. 6.

Referring to FIG. 15, an embodiment of an electronic system 11′ may include a power supply device 20 and an electronic device 40′. In such an embodiment, the electronic device 40′ may include a constant voltage supply unit 200′, a driving circuit 250′, and a voltage adjusting unit 260′. In FIG. 15, the driving circuit 250′ and the voltage adjusting unit 260′ may be the same components as the driving circuit 250 and the voltage adjusting unit 260 of FIG. 8. The constant voltage supply unit 200′ may include an auxiliary LDO circuit 202′. In such an embodiment, the constant voltage supply unit 200′ may further include a resistor 201′ between a power source voltage VDDR and a node N13. The resistor 201′ may include resistors R11 and R12 corresponding to line resistance components.

Referring to FIG. 15, in an embodiment, the constant voltage supply unit 200′ may not include the main LDO circuit of FIG. 8. The voltage adjusting unit 260′ may sense an internal power source voltage VDD and a power source current VDDI. In an embodiment, the voltage adjusting unit 260′ may calculate a power source current IDDI based on a drain-source voltage of a pass transistor T12. In such an embodiment, the voltage adjusting unit 260′ may control the magnitude of the power source voltage VDDR based on the internal power source voltage VDD and the power source current VDDI.

When values of the resistors R11 and R2 corresponding to the line resistance components are small, a voltage difference between the power source voltage VDDR and the internal power source voltage VDD may be reduced to reduce the magnitude of the power source current IDDR.

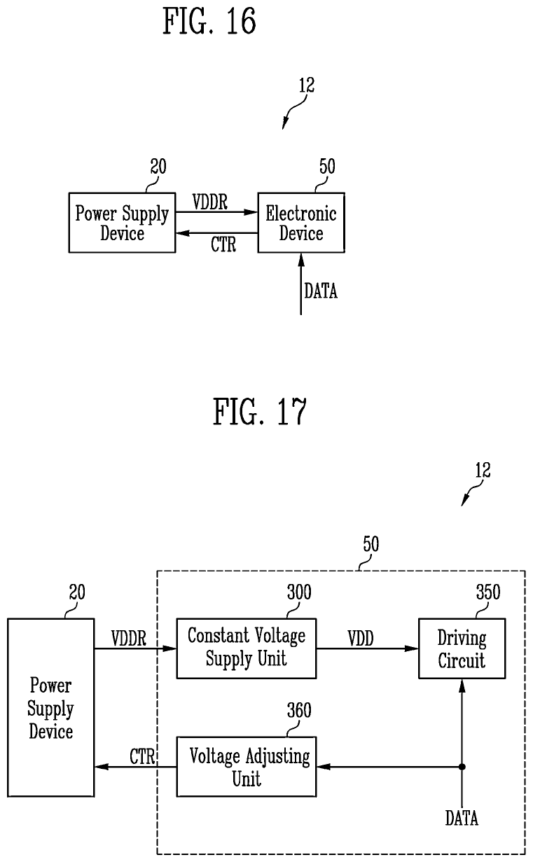

FIG. 16 is a block diagram illustrating an electronic system according to still another embodiment of the invention.

Referring to FIG. 16, an electronic system 12 according to still another embodiment of the invention may include a power supply device 20 and an electronic device 50. As described above with reference to FIG. 1, the power supply device 20 may supply a power source voltage VDDR to the electronic device 50. Hereinafter, any repetitive detailed descriptions of the same or like elements as those of the electronic system 10 of FIG. 1 will be omitted.

The power supply device 20 may supply the power source voltage VDDR required by the electronic device 50. In an embodiment, the electronic device 50 may generate a control signal CTR and transmit the control signal CTR to the power source device 20. The power source device 20 may adjust a voltage level of the power source voltage VDDR based on the control signal CTR. In an embodiment, the electronic device 50 may generate the control signal CTR based on received data DATA. In an embodiment, where the electronic device 50 is a display device, the data DATA may be image data.

FIG. 17 is a block diagram illustrating an embodiment of the electronic system of FIG. 16.

In an embodiment, as described above with reference to FIG. 16, the electronic system 12 may include the power supply device 20 and the electronic device 50. In such an embodiment, as shown in FIG. 17, the electronic device 50 may include a constant voltage supply unit 300, a driving circuit 350, and a voltage adjusting unit 360. The constant voltage supply unit 300 may receive the power source voltage VDDR from the power supply device 20 and supply an internal power source voltage VDD to the driving circuit 350. The driving circuit 350 may operate based on the internal power source voltage VDD. In such an embodiment, the driving circuit 350 may receive the data DATA and operate based on the received data DATA. In an embodiment, where the electronic device 50 is a display device, the driving circuit 350 may perform a function of receiving image data and display an image corresponding to the image data.

The voltage adjusting unit 360 may receive the data DATA and generate the control signal CTR based on the received data DATA. The generated control signal CTR may be transmitted to the power supply device 20. The voltage adjusting unit 360 may be configured or implemented as a processor that analyzes the data DATA and generates the control signal CTR.

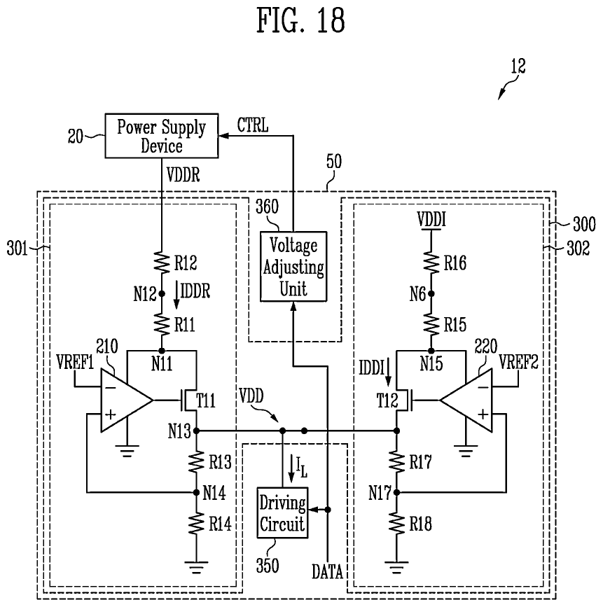

FIG. 18 is a circuit diagram illustrating an embodiment of the electronic system of FIG. 16.

In an embodiment, as described above with reference to FIG. 16, the electronic system 12 may include the power supply device 20 and the electronic device 50. In such an embodiment, as described above with reference to FIG. 17, the electronic device 50 may include the constant voltage supply unit 300, the driving circuit 350, and the voltage adjusting unit 360.

In such an embodiment, as shown in FIG. 18, the constant voltage supply unit 300 may be configured substantially the same as the constant voltage supply unit 200 of FIG. 8. Therefore, any repetitive detailed description of the constant voltage supply unit 300 will be omitted. Similar to the embodiment shown in FIG. 8, the constant voltage supply unit 300 of FIG. 18 may include a main LDO circuit 301 and an auxiliary LDO circuit 302.

The voltage adjusting unit 360 may generate the control signal CTRL to adjust the power source voltage VDDR based on the data DATA transmitted to the driving circuit 350. In an embodiment, for example, the voltage adjusting unit 360 may analyze the data DATA transmitted to the driving circuit 350 and calculate the power source current IDDI to be used when the driving circuit 350 operates based on the data DATA. Therefore, the voltage adjusting unit 360 may calculate the power source current IDDI flowing through the auxiliary LDO circuit 302 based on the data DATA and generate the control signal CTRL to adjust the power source voltage VDDR based on the calculated results. In such an embodiment, as described above, the voltage adjusting unit 360 may be configured or implemented as a processor that analyzes the data and generates the control signal CTRL.

In an embodiment, although not directly shown in FIG. 18, the voltage adjusting unit 360 may include a component for sensing the internal power source voltage VDD supplied to the node N13. In this case, the voltage adjusting unit 360 may generate the control signal CTRL to adjust the power source voltage VDDR in the same manner as described in Table 1 above based on the power source current IDDI calculated based on the data DATA and the sensed internal power source voltage VDD.

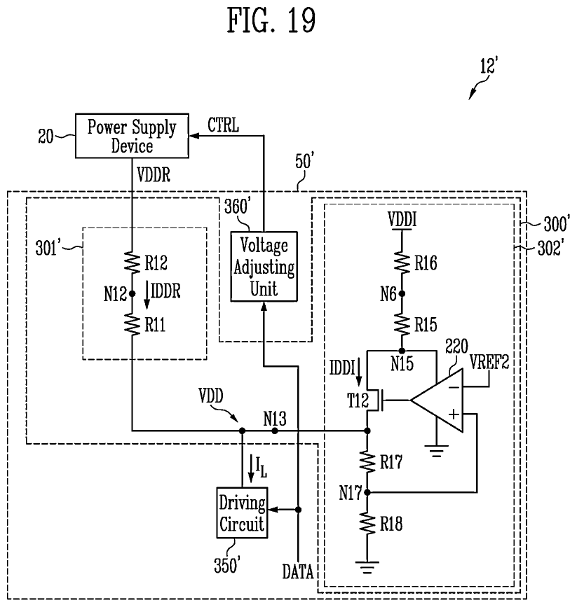

FIG. 19 is a circuit diagram illustrating another embodiment of the electronic system of FIG. 16.

Referring to FIG. 19, an embodiment of an electronic system 12′ may include a power supply device 20 and an electronic device 50′. In such an embodiment, the electronic device 50′ may include a constant voltage supply unit 300′, a driving circuit 350′, and a voltage adjusting unit 360′. In FIG. 19, the driving circuit 350′ and the voltage adjusting unit 360′ may be the same components as the driving circuit 350 and the voltage adjusting unit 360 of FIG. 18. The constant voltage supply unit 300′ may include an auxiliary LDO circuit 302′. In addition, the constant voltage supply unit 300′ may further include a resistor 301′ between a power source voltage VDDR and a node N13. The resistor 301′ may include resistors R11 and R12 corresponding to line resistance components.

Referring to FIG. 19, in an embodiment, the constant voltage supply unit 300′ may not include a main LDO circuit of FIG. 18. The voltage adjusting unit 360′ may generate the control signal CTRL to adjust the power source voltage VDDR based on the data DATA transmitted to the driving circuit 350′. In such an embodiment, the voltage adjusting unit 360′ may sense the internal power source voltage VDD. In this case, the voltage adjusting unit 360′ may generate the control signal CTRL to adjust the power source voltage VDDR in the same manner as described in Table 1 above based on the power source current IDDI calculated based on the data DATA and the sensed internal power source voltage VDD.

According to embodiments of the invention, an electronic device that can be stably driven while reducing power consumption and an electronic system including the electronic device can be provided.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An electronic device comprising:
a constant voltage supply unit which receives a first voltage from a power supply device and generates a second voltage based on the first voltage;
a driving circuit which receives the second voltage from the constant voltage supply unit and operates based on the second voltage; and
a voltage adjusting unit which generates a control signal to change the first voltage based on the second voltage and a power source current corresponding to the second voltage.

2. The electronic device of claim 1, wherein the constant voltage supply unit includes a low drop-out circuit, and
wherein the voltage adjusting unit senses the power source current flowing through the low drop-out circuit.

3. The electronic device of claim 1, wherein the voltage adjusting unit senses the second voltage and generates the control signal based on the power source current and the second voltage.

4. The electronic device of claim 3, wherein when the second voltage is greater than a predetermined reference voltage value and the power source current is less than or equal to a predetermined reference current value, the voltage adjusting unit generates the control signal to control the power supply device in a way such that the first voltage is lowered.

5. The electronic device of claim 3, wherein when the second voltage is less than or equal to a predetermined reference voltage value and the power source current is less than or equal to a predetermined reference current value, the voltage adjusting unit generates the control signal to control the power supply device in a way such that the first voltage is maintained.

6. The electronic device of claim 3, wherein when the second voltage is less than or equal to a predetermined reference voltage value and the power source current is greater than a predetermined reference current value, the voltage adjusting unit generates the control signal to control the power supply device in a way such that the first voltage is raised.

7. The electronic device of claim 3, wherein the constant voltage supply unit includes:
a first low drop-out circuit which receives the first voltage; and
a second low drop-out circuit which receives a third voltage,
wherein the voltage adjusting unit senses the power source current flowing through the second low drop-out circuit.

8. The electronic device of claim 2, wherein the low drop-out circuit receives a third voltage.

9. The electronic device of claim 1, wherein the driving circuit receives data, and
wherein the voltage adjusting unit calculates the power source current based on the data.

10. The electronic device of claim 9, wherein
the driving circuit performs an operation of displaying an image, and
the data is image data.

11. The electronic device of claim 9, wherein the voltage adjusting unit senses the second voltage and generates the control signal based on the power source current and the second voltage.

12. The electronic device of claim 1, wherein the driving circuit performs an operation of displaying an image, and
wherein the voltage adjusting unit generates the control signal every frame cycle of the driving circuit.

13. An electronic system comprising:
a power supply device which generates a first voltage based on a control signal;
a constant voltage supply unit which generates a second voltage based on the first voltage;
a driving circuit which operates based on the second voltage generated by the constant voltage supply unit; and
a processor which generates the control signal based on the second voltage and a power source current corresponding to the second voltage.

14. The electronic system of claim 13, wherein the constant voltage supply unit includes a low drop-out circuit, and
wherein the processor senses the power source current flowing through the low drop-out circuit and the second voltage, and generates the control signal based on the power source current and the second voltage.

15. The electronic system of claim 14, wherein when the second voltage is greater than a predetermined reference voltage value and the power source current is less than or equal to a predetermined reference current value, the processor generates the control signal to control the power supply device in a way such that the first voltage is lowered.

16. The electronic system of claim 14, wherein when the second voltage is less than or equal to a predetermined reference voltage value and the power source current is less than or equal to a predetermined reference current value, the processor generates the control signal to control the power supply device in a way such that the first voltage is maintained.

17. The electronic system of claim 14, wherein when the second voltage is less than or equal to a predetermined reference voltage value and the power source current is greater than a predetermined reference current value, the processor generates the control signal to control the power supply device in a way such that the first voltage is raised.

18. The electronic system of claim 14, wherein the constant voltage supply unit includes:
a first low drop-out circuit which receives the first voltage; and
a second low drop-out circuit which receives a third voltage,
wherein the processor senses the power source current flowing through the second low drop-out circuit.

19. The electronic system of claim 14, wherein the low drop-out circuit receives a third voltage.

20. The electronic system of claim 13, wherein the electronic device is a display device, and
wherein the processor calculates the power source current based on image data transmitted to the display device.
